(19) United States
(12) Patent Application Publication
(10) Pub. No.: US 2026/0225297 A1
(43) Pub. Date: Aug. 6, 2026

(54) AIR VENT ASSEMBLY COMPRISING PLURALITY OF PARTS AND INJECTION MOLDING APPARATUS COMPRISING SAME

(71) Applicant: Samsung Electronics Co., Ltd., Suwon-si (KR)

(72) Inventors: Sangwook LEE, Suwon-si (KR); Jonghyun KIM, Suwon-si (KR); Yongyeon KIM, Suwon-si (KR); Yonghyun NAM, Suwon-si (KR); Jinman AHN, Suwon-si (KR); Changju LEE, Suwon-si (KR); Jindeuk JEON, Suwon-si (KR); Sangwoo CHA, Suwon-si (KR); Younghee CHOI, Suwon-si (KR); Hyunsuk CHOI, Suwon-si (KR)

(21) Appl. No.: 19/631,448

(22) Filed: Mar. 27, 2026

Related U.S. Application Data
(63) Continuation of application No. PCT/KR2024/012248, filed on Aug. 16, 2024.

(30) Foreign Application Priority Data
Oct. 7, 2023 (KR) 10-2023-0133843
Oct. 27, 2023 (KR) 10-2023-0146099

(51) Int. Cl. B29C 45/34

(52) U.S. Cl. CPC B29C 45/34

(57) ABSTRACT

An air vent assembly is provided. The air vent assembly comprises: a first part including a plurality of protruding portions, and a second part formed as a single unit and configured with a metal material, the second part including a plurality of slits into which each of the plurality of protruding portions of the first part is inserted and a receiving groove in which the first part is accommodated, wherein each of the plurality of slits includes a protrusion protruding from a partition wall that separates the plurality of slits into each of the plurality of slits, the protrusion contacting the plurality of protruding portions, and wherein the protrusion maintains a gap between the plurality of protruding portions and the partition wall, by separating a protruding portion accommodated in a slit from the partition wall and limiting a movement of the protruding portion in a direction perpendicular to a longitudinal direction of the slits.

### CROSS-REFERENCE TO RELATED APPLICATION(S)

This application is a continuation application, claiming priority under 35 U.S.C. § 365(c), of an International application No. PCT/KR2024/012248, filed on Aug. 16, 2024, which is based on and claims the benefit of a Korean patent application number 10-2023-0133843, filed on Oct. 7, 2023, in the Ministry of Intellectual Property (MOIP), and of a Korean patent application number 10-2023-0146099, filed on Oct. 27, 2023, in the Ministry of Intellectual Property (MOIP), the disclosure of each of which is incorporated by reference herein in its entirety.

### BACKGROUND

### 1. Field

The disclosure relates to an air vent assembly including a plurality of parts and an injection molding device including the same.

### 2. Description of Related Art

Injection molding may be used for molding a thermoplastic resin or a thermosetting resin. A molding device for the injection molding may include an air vent in order to discharge air or gas contained in a resin disposed in a cavity inside a mold used for the injection molding.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an air vent assembly including a plurality of parts and an injection molding device including the same.

In accordance with an aspect of the disclosure, an air vent assembly including a first part including a plurality of protruding portions, and a second part formed as a single unit and configured with a metal material, the second part including a plurality of slits into which each of the plurality of protruding portions of the first part is inserted and a receiving groove in which the first part is accommodated, wherein each of the plurality of slits includes a protrusion protruding from a partition wall that separates the plurality of slits into each of the plurality of slits, the protrusion contacting the plurality of protruding portions, and wherein the protrusion maintains a gap between the plurality of protruding portions and the partition wall, by separating a protruding portion accommodated in a slit from the partition wall and limiting a movement of the protruding portion in a direction perpendicular to a longitudinal direction of the slit.

In accordance with another aspect of the disclosure, an injection molding device is provided. The injection molding device includes a first mold including a cavity configured to accommodate a resin, a second mold including a core configured to press the resin injected in the cavity and configured to be movable with respect to the first mold, and an air vent assembly configured to transfer gas discharged from the resin to an outside of the second mold according to a pressure of the resin and coupled to a seating portion formed on the core, wherein the air vent assembly comprise a first part including a plurality of protruding portions, and a second part formed as a single unit and configured with a metal material, the second part including a plurality of slits into which each of the plurality of protruding portions is inserted and a receiving groove in which the first part is accommodated, wherein each of the slits includes a protrusion protruding from a partition wall that separates the slits into each of the slits, the protrusion contacting the protruding portions, and wherein the protrusion separates a protruding portion accommodated in a slit where the protrusion is disposed from the partition wall and limit a movement of the protruding portion in a direction perpendicular to a longitudinal direction of the slit while the resin is injected into the cavity.

Additional aspects will be set forth in part in the description which follows and, in part, will be apparent from the description, or may be learned by practice of the presented embodiments.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a partial perspective view indicating an injection molding device according to an embodiment of the disclosure.

FIG. 2 is a cross-sectional view indicating an injection molding device according to an embodiment of the disclosure.

FIG. 3 is a perspective view indicating an air vent assembly according to an embodiment of the disclosure.

FIG. 4A is diagrams indicating a first part of an air vent assembly according to an embodiment of the disclosure.

FIG. 4B is a diagram indicating a side surface of an bridge of a first part according to an embodiment of the disclosure.

FIG. 4C is an enlarged view of a portion of an air vent assembly according to coupling of a first part and a second part according to an embodiment of the disclosure.

FIG. 5 illustrates diagrams indicating a second part of an air vent assembly according to an embodiment of the disclosure.

FIG. 6 is a cross-sectional view of an air vent assembly in which a first part and a second part are assembled according to an embodiment of the disclosure.

FIGS. 7A and 7B are top views indicating an air vent assembly according to various embodiments of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

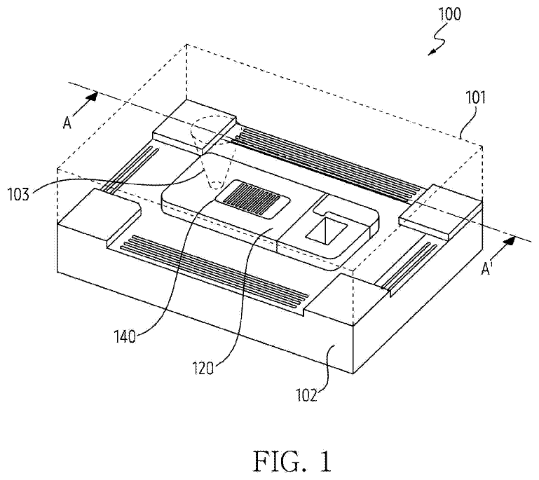

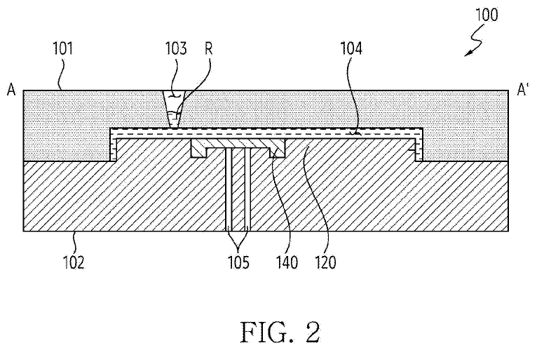

FIG. 1 is a partial perspective view indicating an injection molding device according to an embodiment of the disclosure. FIG. 2 is a cross-sectional view indicating an injection molding device according to an embodiment of the disclosure.

Referring to FIGS. 1 and 2, an injection molding device 100 may mold a molten resin. Injection molding is a process in which a resin in a powder state is melted by applying heat, and the molten resin is injected into the mold and then cooled to form a product.

The injection molding device 100 may include a first mold 101 and a second mold 102. One of the first mold 101 or the second mold 102 may be fixed, and another one may move. For example, the second mold 102 may be a fixed mold, and the first mold 101 may be a movable mold. The first mold 101 may linearly move toward the second mold 102. The first mold 101 and the second mold 102 face each other, and may be selectively opened or closed according to a movement of the first mold 101.

The first mold 101 may form a molded product by contacting the second mold 102. The molded product may be formed from resin or plastic, but is not limited thereto. In a state in which the resin or the plastic, which is a molding material R, is melted, it may be introduced into the first mold 101 and the second mold 102 through an inlet 103. The molding material R may by be pressed through an external device and transmitted to the inlet 103 through a nozzle. The molten molding material R introduced through the inlet 103 may reach a cavity 104. After sufficiently filling the cavity 104, the molten molding material R may be cooled. The molding material R may form a molding product by being cooled in a mold.

The injection molding device 100 may further include an air vent assembly 140 fastened to a core 120 of the second mold 102. The air vent assembly 140 may be configured to discharge gas included in the molding material R or air in the cavity 104 out of the mold while processing the injection molding. A vent in the air vent assembly 140 may be connected to a vent 105 formed in the second mold 102 to discharge the air in the cavity 104 or the gas included in the molding material R to the outside of the second mold 102.

The air vent assembly 140 may include a vent (or a gap or an air passage) extending from a surface facing the cavity 104 to a surface facing the vent 105 of the second mold 102. Through the vent, the air in the cavity 104 or the gas released from the molding material R may be discharged to the vent 105 of the second mold 102.

According to the above-described embodiment of the disclosure, the injection molding device 100 may remove the gas generated from the resin injected into the mold by including the air vent assembly 140. By removing the gas or the air in the mold through the air vent assembly 140, a quality of the molded product may be improved, and corrosion or contamination of the mold may be reduced.

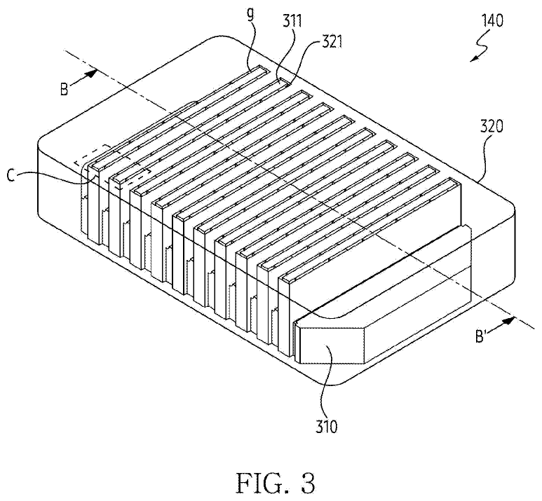

FIG. 3 is a perspective view indicating an air vent assembly according to an embodiment of the disclosure.

Referring to FIG. 3, an air vent assembly 140 may include a first part 310 and a second part 320. The first part 310 may be seated in a core (e.g., the core 120 of FIG. 2), and the second part 320 may be fastened to a second mold (e.g., the second mold 102 of FIG. 2). By fastening the second part 320, the air vent assembly 140 may be fixed to the second mold 102. The first part 310 may be disposed between the second part 320 and the second mold 102 (or the core 120). The first part 310 may be fixed to the second mold 102 by a pressure of the second part 320 and the second mold 102.

The first part 310 may include a plurality of protruding portions 311. The second part 320 may include a plurality of slits 321 into which the plurality of protruding portions 311 are inserted. The first part 310 may be integrally formed. The first part 310 may formed as a single unit. The first part 310 may be formed of one metal or one alloy. The first part 310 may be formed by processing one metal base material. For example, the plurality of protruding portions 311 may be formed through computer numerical control (CNC) processing or wire electrical discharge, of one metal base material. The second part 320 may further include a receiving groove in which the first part 310 is seated. The second part 320 may be integrally formed. The second part 320 may formed as a single unit. For example, the second part 320 may be formed of a single material. The second part 320 may be formed of one metal or one alloy. The second part 320 may form the plurality of slits 321 and the receiving groove by processing a metal base material. For example, the plurality of slits 321 may be formed through the wire electrical discharge of the base material of the second part 320. The receiving groove in which the first part 310 is seated may be formed through the CNC processing. The air vent assembly 140 formed by assembling the first part 310 and the second part 320 formed of a single material may reduce a tolerance with respect to outer dimensions, as compared with a case in which an air vent is formed by stacking a plurality of plates.

The plurality of protruding portions 311 inserted into the plurality of slits 321 may be formed to be smaller than the plurality of slits 321. The plurality of protruding portions 311 may be formed to be spaced apart from a wall forming the plurality of slits 321. Gas in a molding material R may be discharged to the outside of a second mold (e.g., the second mold 102 of FIG. 1) through a gap g between the wall and the plurality of protruding portions 311.

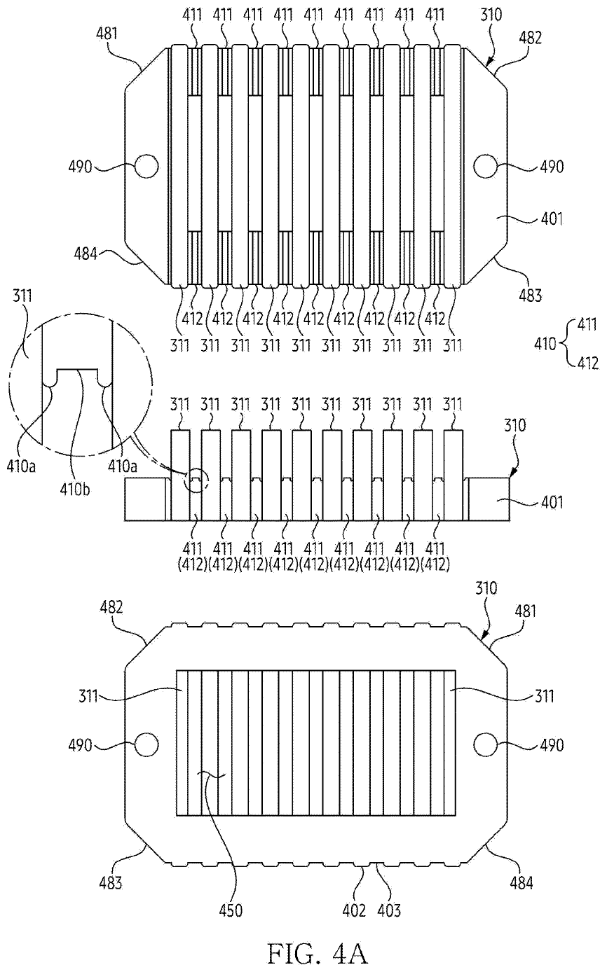

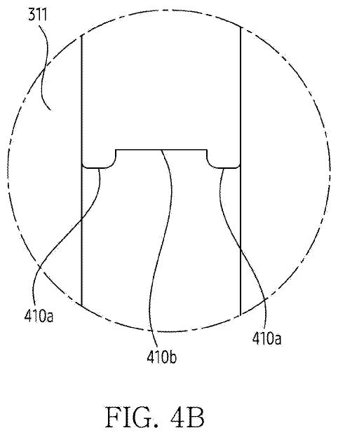

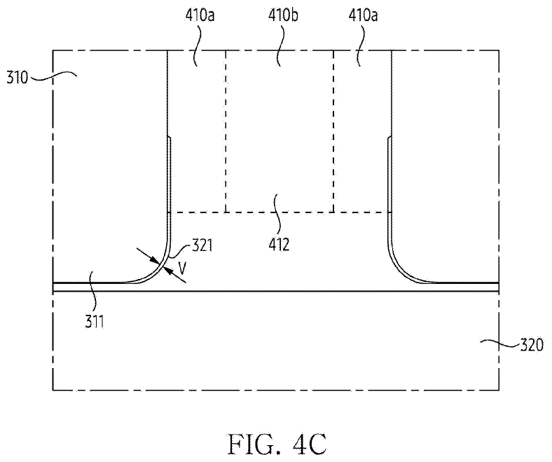

According to the above-described embodiment of the disclosure, the air vent assembly 140 may further include a structure for forming the gap g between the plurality of protruding portions 311 and the wall forming the plurality of slits 321. The structure for forming the gap g for the air vent will be described with reference to FIGS. 4A to 6.

FIG. 4A is diagrams indicating a first part of an air vent assembly according to an embodiment of the disclosure. FIG. 4B is a diagram indicating a side surface of a bridge of a first part according to an embodiment of the disclosure. FIG. 4C is an enlarged view of a portion of an air vent assembly according to coupling of a first part and a second part according to an embodiment of the disclosure.

Referring to FIG. 4A, a first part 310 may include a base 401, a plurality of protruding portions 311, and a plurality of bridges 410. The first part 310 may be a structure remaining after being processed from one base material. For example, the first part 310 may include the plurality of protruding portions 311, the bridges 410, and the base 401 integrally formed from one material.

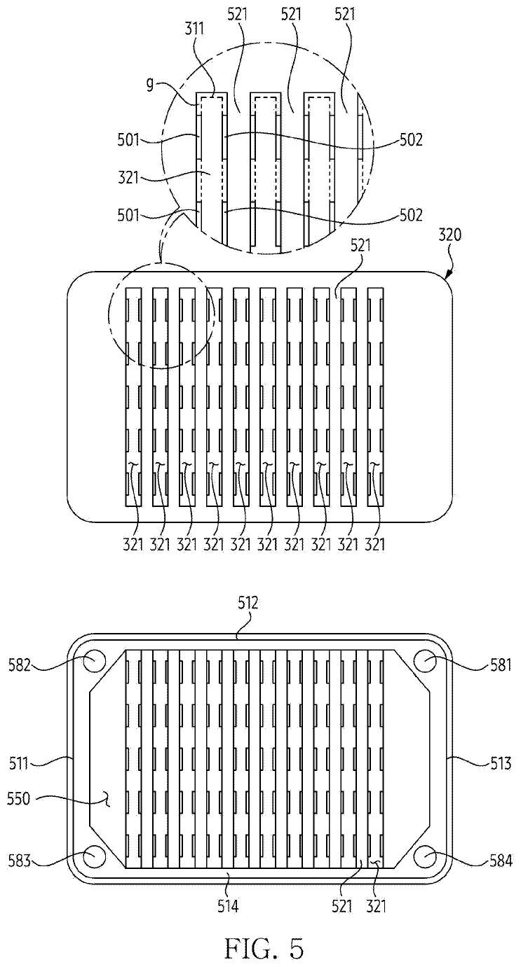

The base 401 may be inserted into a receiving groove (e.g., a receiving groove 550 of FIG. 5) formed in a second part 320. The base 401 may contact a mold when fastened to the mold. For example, the base 401 may be seated in a seating portion formed in a core 120 of a second mold (e.g., the second mold 102 of FIG. 1).

The plurality of protruding portions 311 may protrude from the base 401. The plurality of protruding portions 311 may be referred to as a plate or a flat plate member, in terms of being formed in a plate shape having a thickness thinner relative to a protruding length. The protruding portions 311 may have a thickness smaller than a width of slits 321. A difference between the thickness of the protruding portions 311 and the width of the slits 321 may be about 0.01 mm to about 0.025 mm. The difference between the thickness of the protruding portions 311 and the width of the slits 321 may be determined based on a discharge of air and an introduction of a resin into the slits 321. When the difference between the thickness of the protruding portions 311 and the width of the slits 321 is large, gas in a molding material R is easily discharged, but the molding material R may be introduced into the slits 321. The molding material R introduced into the slits 321 may increase a defect rate of a molding product or decrease a quality of the molding product. When the difference between the thickness of the protruding portions 311 and the width of the slits 321 is small, it may be difficult to discharge the gas in the molding material R. When it is difficult to discharge the gas in the molded material R, discoloration of the molded product may occur, a defect due to gas residue may occur, or an appearance defect due to air bubbles may occur. Since a gap (e.g., the gap g of FIG. 3) between the protruding portions 311 and a wall forming the slits 321 functions as an air vent, a width of the gap g may be formed to be 0.005 mm to 0.015 mm to reduce the defect. For example, when the width of each of the slits 321 is 1 mm, the thickness of each of the protruding portions 311 may be 0.98 mm to provide an air vent having a width of 0.01 mm. The protruding portions 311 may be spaced apart from each other. When the first part 310 and the second part 320 are assembled, the wall forming the slits 321 may be inserted into a gap between the protruding portions 311.

Sets 411 and 412 of bridges may connect the protruding portions 311. The sets 411 and 412 of bridges may be remaining portions in which portions between the protruding portions 311 are removed from the base material, for a connection of the protruding portions 311. The sets 411 and 412 of bridges may be at least a portion of a remaining region, which is removed from the base material, to form a space 450. An end of each of the protruding portions 311 may be connected to a bridge configuring the set 411 of first bridges, and another end of each of the protruding portions 311 may be connected to a bridge configuring the set 412 of second bridges. The sets 411 and 412 of bridges may form a continuous surface with the base 401. The base 401 and the sets 411 and 412 of bridges may define the space 450. A periphery of the space 450 may be surrounded by the base 401 and the sets 411 and 412 of bridges. As another example, the base 401 may include the set 411 of bridges. The base 401 may include an opening forming the space 450 inside the base 401, and the protruding portions 311 may be supported by a portion of the base 401 extending in a direction perpendicular to a longitudinal direction of the protruding portions 311.

The space 450 between the set 411 of the first bridges and the set 412 of the second bridges may be continuous(or connected) with a gap g of an air vent assembly 140. The gap g may be a distance between the protruding portions 311 and walls forming the slits 321.

The sets 411 and 412 of the plurality of bridges may include a structure for providing air or gas introduced into the gap g, to the space 450. For example, each of bridges of the set 411 of the first bridges and the set 412 of the second bridges may include a groove 410a dug along an edge contacting the plurality of protruding portions 311. The groove 410a may be continuous(or connected) with the space 450. Each of the bridges of the set 411 of the first bridges and the set 412 of the second bridges may be connected to the end of the plurality of protruding portions 311. Each of the bridges of the set 411 of the first bridges and the set 412 of the second bridges may include the groove 410a extending along the edge contacting the protruding portions 311 and a surface 410b supporting a wall of the second part 320. The groove 410a may be dug in a semicircular shape. The groove 410a may be formed by wire electrical discharge processing.

Referring to FIG. 4B, the groove 410a is not limited to the semicircular shape and may include another shape. The groove 410a may have an arc shape at a boundary portion contacting the protruding portions 311, and the groove 410a may have an arc shape corresponding to the arc shape at a boundary portion with the surface 410b. When the groove 410a is formed narrowly between the protruding portions 311 and the surface 410b as illustrated in FIG. 4A, the groove 410a may be formed in the semicircular shape. When a distance between the protruding portions 311 and the surface 410b in which the groove 410a is formed is relatively wide as illustrated in FIG. 4B, it may have a groove shape with a rounded periphery. For example, a width of the groove 410a of FIG. 4B may be wider than a diameter of a circle to be rounded. Shapes of the groove 410a and the surface 410b are not limited thereto. The shape of the groove 410a may be formed in a shape for limiting interference between the protruding portions 311 and the wall between the slits 321 of the second part 320 disposed on the surface 410b. The shape of the groove 410a may be formed in a shape for connecting to a gap for a vent between the protruding portions 311 and the slits 321.

Referring back to FIG. 4A, in order to be inserted into a receiving groove (e.g., a receiving groove 550 of FIG. 5) of the second part 320, the base 401 of the first part 310 may have a shape corresponding to the receiving groove. For example, each corner 481, 482, 483, and 484 of the base 401 of the first part 310 may be chamfered to be inserted into the receiving groove. However, it is not limited thereto, and a shape of each corner 481, 482, 483, and 484 of the base 401 may be determined according to a shape of the receiving groove 550. For example, when a shape of a corner of the receiving groove 550 is rounded, each corner 481, 482, 483, and 484 of the base 401 may be rounded.

The first part 310 may include a concavo-convex shape dug from a side surface of the base 401. The first part 310 may include a convex portion 402 and a concave portion 403 dug from the side surface of the base 401. The convex portion 402 and the concave portion 403 may be repeatedly disposed along the side surface of the base 401. When the first part 310 and the second part 320 are assembled, the convex portion 402 may be configured to contact the receiving groove 550, and the concave portion 403 may be spaced apart from the receiving groove 550. The base 401 including the concave portion 403 may be configured to transfer gas introduced from the gap g to a vent 105 of the second mold 102. The concave portion 403 may be connected to the gap g. For example, a space between the concave portion 403 and the receiving groove 550 may be connected to the grooves 410a formed in the sets 411 and 412 of bridges by extending along the side surface of the base 401. The space between the concave portion 403 and the receiving groove 550 may be connected to the gap g through the groove 410a connected to the gap g formed according to the assembly of the first part 310 and the second part 320. During an injection molding process, the gas released from the molding material R may be transferred to the vent 105 of the second mold 102 through the gap g, the groove 410a, and the space between the concave portion 403 and the receiving groove 550.

Referring to FIG. 4C, the convex portion 402 may be formed at the end of the plurality of the protruding portions 311, and the concave portion 403 may be formed at an end of the bridges 410. At least a portion of the protruding portions 311 may be spaced apart from the slit 321 to provide a vent V. A length of the protruding portions 311 may be formed to be relatively longer than that of the bridge 412. For example, the protruding portions 311 in which the convex portion 402 is formed may be formed to be longer than the bridges 410 in which the concave portion 403 is formed. By forming the protruding portions 311 long (e.g., the convex portion 402 is formed on the protruding portions 311), an air vent assembly (e.g., the air vent assembly 140 of FIG. 1) may secure a relatively wide space for the vent V.

The groove 410a may be connected to the vent V, connected to the concave portion 403 and the space 450, and may be configured to transfer volatile gas or air transferred through the vent V to the outside of the mold.

Referring back to FIG. 4A, the first part 310 may define a hole 490 penetrating the base 401. An external object may be inserted into the hole 490. The external object may be a bolt. The hole 490 may form a screw line corresponding to a screw line of the bolt on an inner circumferential surface. The bolt may be inserted along the screw line formed on the inner circumferential surface of the hole 490 to press the second part 320. As the bolt protrudes toward the second part 320 after penetrating the hole 490, a surface of the second part 320 may be pressed. The first part 310 may move away from the second part 320 by a protruding distance of the bolt. The first part 310 may be separated from the second part 320 by a nut protruding through the hole 490.

The space 450 formed in the base 401 may correspond to a shape of the seating portion formed in the core 120 of the second mold 102. A height of the air vent assembly 140 coupled to the seating portion in which the vent 105 is formed without penetrating the entire second mold 102 may be low. When a length of a vent portion increases, it may be difficult to discharge gas. In order to prevent the molding material R from being introduced into the gap g, when the length of the gap g having a narrow width of approximately 0.005 mm to 0.015 mm increases, resistance to the flow of air or gas may increase. The air vent assembly 140 having a low height may reduce a length of the ventilation portion through which the gas passes, thereby easily discharging air in a cavity 104 or gas in the molding material R. For example, when the height of the air vent assembly 140 is 10 mm, a length of the vent portion may be set to 10 mm. The air vent assembly 140 having a structure seated on the second mold 102 may reduce the length of the vent portion than the air vent penetrating the second mold 102.

FIG. 5 illustrates diagrams indicating a second part of an air vent assembly according to an embodiment of the disclosure.

Referring to FIG. 5, a second part 320 may include a plurality of slits 321 and a partition wall 521.

Each of the plurality of protruding portions 311 may be inserted into the plurality of slits 321. The plurality of protruding portions 311 may be spaced apart from the partition wall 521 forming the plurality of slits 321. A gap g between the plurality of protruding portions 311 and the partition wall 521 may operate as an air vent. The plurality of slits 321 may extend in a direction parallel to each other. The plurality of slits 321 may be spaced apart from each other. The partition wall 521 may be disposed between the plurality of slits 321. The partition wall 521 may be formed in a connected form without being separated. The partition wall 521 may be a remaining region after forming the slits 321 formed through wire electrical discharge in the second part 320.

The second part 320 may further include protrusions 501 and 502. The protrusions 501 and 502 may be configured to maintain the gap g between the protruding portions 311 and the partition wall 521. The protrusions 501 and 502 may protrude from the partition wall 521 by 0.005 mm to 0.015 mm. For example, each of the protrusions 501 and 502 may have a protrusion length of 0.01 mm. The length of the protrusions 501 and 502 may determine a width of the gap g. For example, the width of the gap g may be 0.005 mm to 0.015 mm, which is the protruding length of the protrusions 501 and 502. The protrusions 501 and 502 may be spaced apart from each other in an extending direction of the partition wall 521 (or a longitudinal direction of the slit 321). For example, the protrusions 501 and 502 may be spaced apart from each other by 2 mm to 4 mm in the extending direction of the partition wall 521. The separated space may be connected to the gap g. The protrusions 501 and 502 may separate a protruding portion inserted into a slit from the partition wall. For example, the protrusions 501 and 502 may protrude from the partition wall 521 into each of the slits 321. The protrusions 501 and 502 may contact the protruding portions 311 when a first part 310 and the second part 320 are assembled. For example, the first protrusion 501 protruding from the partition wall 521 forming a surface of a slit among the slits 321 may contact a surface of the protruding portion inserted into the slit. The second protrusion 502 protruding from the partition wall 521 forming another surface of the slit among the slits 321 may contact another surface of the protruding portion inserted into the slit. The protruding portions 311 disposed between the first protrusion 501 and the second protrusion 502 may be fixed inside each of the slits 321. A movement of the protruding portions 311 in a direction perpendicular to a longitudinal direction of the protruding portions 311 (or the longitudinal direction of the slit 321) may be limited.

The air vent assembly 140 may constantly maintain the width of the gap g by limiting the movement of the protruding portions 311. The constantly maintained gap g may facilitate a discharge of gas discharged from a molding material R and gas in a cavity 104, and may restrict inflow of the molding material R into the gap g, thereby improving a quality of a molded product.

The second part 320 may include side walls 511, 512, 513, and 514 extending to a rear surface of the second part 320 and a receiving groove 550. The side walls 511, 512, 513, and 514 may form a side surface of the second part 320. Since a side surface of the air vent assembly 140 in which the first part 310 and the second part 320 are assembled are the same as the side surface of the second part 320, the side walls 511, 512, 513, and 514 may form the side surface of the air vent assembly 140.

The receiving groove 550 may be defined by the side walls 511, 512, 513, and 514. For example, the receiving groove 550 may be surrounded by the side walls 511, 512, 513, and 514. A shape of the receiving groove 550 may correspond to a shape of a base 401 of the first part 310. The receiving groove 550 may provide a space in which the base 401 may be accommodated. The receiving groove 550 may have a shape corresponding to shapes of corners 481, 482, 483, and 484 of the base 401.

The second part 320 may further include fastening grooves 581, 582, 583, and 584. The fastening grooves 581, 582, 583, and 584 may be formed on the rear surface of the second part 320. The fastening grooves 581, 582, 583, and 584 may have a structure for being fastened to a second mold (e.g., the second mold 102 of FIG. 1). The second mold 102 and the second part 320 may be coupled through a screw inserted into the fastening grooves 581, 582, 583, and 584. The fastening grooves 581, 582, 583, and 584 may include a screw line. Although it is illustrated that the second mold 102 and the second part 320 are screw-coupled, they are only exemplary and are not limited thereto. For example, the second mold 102 and the second part 320 may be fastened through screw coupling, fitting coupling, hook coupling, or another mechanical coupling.

The side walls 511, 512, 513, and 514 may have a chamfer shape in a region (e.g., a corner region of the second part 320) where each of the side walls 511, 512, 513, and 514 meets to provide a region for forming the fastening grooves 581, 582, 583, and 584. The chamfer shape may be a shape corresponding to the corners 481, 482, 483, and 484 of the first part 310. To provide a space for the fastening grooves 581, 582, 583, and 584, the corners 481, 482, 483, and 484 of the first part 310 may be chamfered.

The second part 320 according to the above-described embodiment may facilitate gas discharge of the air vent assembly 140. The protrusions 501 and 502 of the second part 320 may fix the protruding portions 311 and limit the movement of the protruding portions 311, thereby constantly maintaining the width of the gap g. The constantly maintained gap g may discharge the gas discharged from the molding material R and the gas in the cavity 104 to the outside of the second mold 102. By maintaining the narrowly formed gap g, the air vent assembly 140 may improve the quality of the molded product by limiting the inflow of the molded material R into the interior.

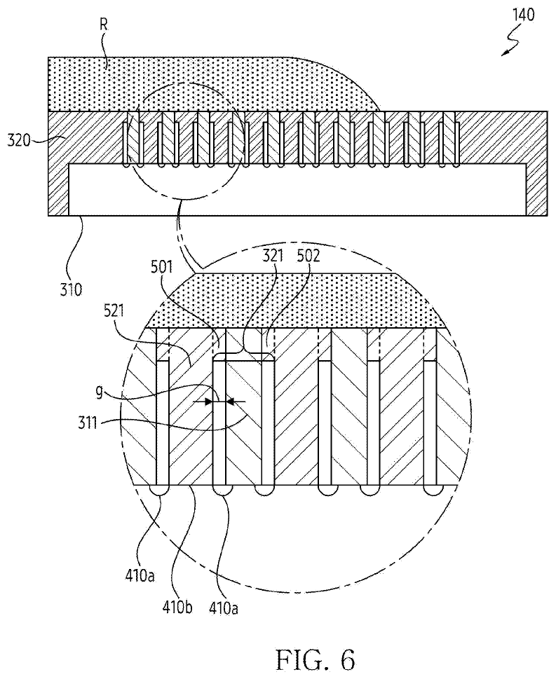

FIG. 6 is a cross-sectional view of an air vent assembly in which a first part and a second part are assembled according to an embodiment of the disclosure.

An air vent assembly 140 may constantly maintain a gap g. Each of protruding portions 311 of a first part 310 of the air vent assembly 140 may be disposed on slits 321 of a second part 320. Each of the protruding portions 311 disposed in the slits 321 may be fixed by protrusions 501 and 502 protruding from a partition wall 521. The protrusions 501 and 502 may press and fix a portion of both side surfaces of the protruding portions 311.

When a molding material R is introduced into a cavity (e.g., the cavity 104 of FIG. 2) as the air vent assembly 140 is attached to a second mold (e.g., the second mold 102 of FIG. 1), the protruding portions 311 may receive a force in an injection direction (e.g., a right direction) of the molding material R by injection of the molding material R. The protrusions 501 and 502 may prevent a width of the gap g from changing due to pushing of the protruding portions 311. Bridges 410 may support the partition wall 521. The partition wall 521 may be seated on a surface 410b of the bridges 410. Semicircular grooves 410a formed in the bridges 410 may be connected to the gap g, and gas introduced into the gap g through the gap g may be transferred to the outside of the first part 310. For example, gas released from the molding material R may be transferred to a groove 550 of the first part 310 through the gap g, and the gas transferred to the groove 550 may be discharged to the outside of the second mold 102 through a vent 105 of the second mold 102.

According to the above-described embodiment of the disclosure, the air vent assembly 140 may constantly maintain the width of the gap g through the protrusions 501 and 502. The gas released from the molding material R and the gas in the cavity (e.g., the cavity 104 of FIG. 2) may be discharged to the outside through the gap g maintained at the constant width.

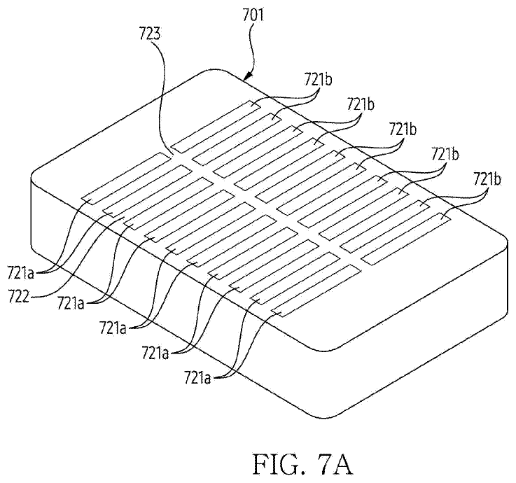

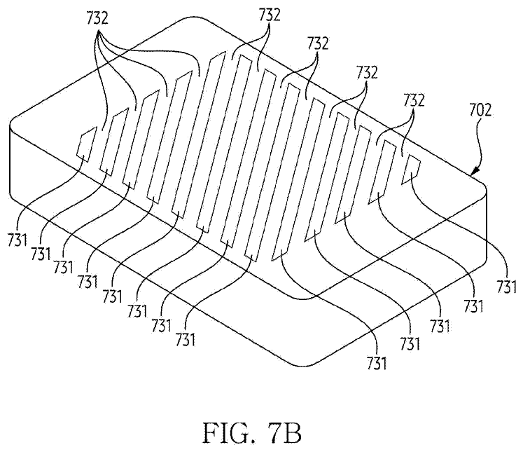

FIGS. 7A and 7B are top views indicating an air vent assembly according to various embodiments of the disclosure.

Referring to FIG. 7A, slits 721a and 721b of an air vent assembly 701 may be spaced apart in a first direction by a first partition wall 722. A second partition wall 723 may separate the slits 721a and 721b in a second direction perpendicular to the first direction.

The first partition wall 722 may correspond to the partition wall 521 of FIG. 5. The first partition wall 722 may extend in the second direction. The second partition wall 723 may divide the slits 721a and 721b by extending in the first direction.

A second part of the air vent assembly 701 may have protruding portions corresponding to shapes of the separated slits 721a and 721b.

Referring to FIG. 7B, an air vent assembly 702 may have slits 731 extending in a diagonal direction on a side wall of a first part. The slits 731 may be divided by a partition wall 732. A second part of the air vent assembly 702 may include protruding portions extending in the diagonal direction to correspond to a shape of the slits 731.

The protruding portions and the slits 731, extending in the diagonal direction may be inclined in a moving direction of a resin and receive a force, thereby preventing the protruding portions from being pushed according to an injection pressure.

The air vent assemblies 701 and 702 of FIGS. 7A and 7B may include the shapes of the bridges 411 and 412, the convex portion 402 and the concave portion 403, and a structure similar to the protrusions 501 and 502 of FIG. 5.

For example, through a groove 410a formed in sets 411 and 412 of bridges, it may transfer gas to the outside of a second mold (e.g., the second mold 102 of FIG. 1) through a gap and the concave portion 403 of the air vent assemblies 701 and 702. It may include the protrusions 501 and 502 to prevent the protruding portion from being pushed.

Not only disposition of the slits 721a, 721b, and 731, but also a shape of the slits may be variously formed. For example, the slits are formed in a rectangular structure, but are not limited thereto and may be formed in a trapezoidal structure as illustrated in FIG. 7B. The slits may be rectangular slits with rounded corners, slits with ends processed in a semicircular shape, or elliptical slits.

According to the above-described embodiment of the disclosure, an air vent assembly 140, 701, or 702 may provide an air vent assembly formed of a single material, thereby shortening a vent portion and enabling stable discharge of gas. By shortening a height of the air vent assembly 140, 701, or 702, it may be disposed on a mold and stably fixed.

Hereinbefore, a structure of an air vent assembly and an injection molding device including the air vent assembly has been described with reference to FIGS. 1 to 7B. Hereinafter, an operation of the injection molding device will be described.

Referring to FIGS. 2 and 6, a first mold 101 may provide a cavity 104 for manufacturing a molded product by moving toward a second mold 102. The cavity 104 may have a shape corresponding to a shape of the molded product. A molding material R may be injected into the cavity 104 through an inlet 103. The molding material R may be injected into the inlet 103 through a nozzle, and an injection pressure may be applied into the cavity 104 formed by a core 120 and the first mold 101 while the molding material R is injected. Even after the molding material R is injected, the pressure may be maintained for the shape of the molded product while the molding material R is cooled.

The injection pressure applied while or after the molding material R is introduced may press protruding portions 311. The protrusions 501 and 502 toward the inside of the slit may reduce pushing due to the injection pressure by fixing the protruding portions 311. For example, a gap g between the protruding portions 311 and the partition wall 521 may be maintained despite the injection pressure applied while or after the molding material R is introduced. In the molding material R, internal gas may be discharged through the gap g by the pressure. The gas to be discharged through the gap g may be discharged to the outside through a vent 105 of the second mold 102.

The molding material R in the cavity 104 of the first mold 101 and the second mold 102 may be cooled to form an injection product. The air vent assembly 140 may improve a quality of the injection product by preventing the inflow of the molding material R into the gap g that is constantly maintained.

There may be a need for a method for discharging gas in a resin or air in a cavity of a mold to the outside. An air vent assembly may provide a configuration for reducing a length of a vent and for stably discharging the gas in the resin.

The technical problems to be achieved in this document are not limited to those described above, and other technical problems not mentioned herein will be clearly understood by those having ordinary knowledge in the art to which the disclosure belongs, from the following description.

According to the above-described embodiment of the disclosure, an air vent assembly (e.g., the air vent assembly 140 of FIG. 1) may comprise a first part (e.g., the first part 310 of FIG. 3) and a second part (e.g., the second part 320 of FIG. 3). The first part 310 may include a plurality of protruding portions 311 protruding toward the second part. The second part 320 may include a plurality of slits (e.g., the plurality of slits 321 of FIG. 3) and a receiving groove (e.g., the receiving groove 550 of FIG. 5). The plurality of slits 321 may accommodate each of the plurality of protruding portions 311. The receiving groove 550 may provide a space in which the first part 310 is disposed. The second part 320 may be integrally formed and may be formed of a metal material.

Each of the slits 321 may include a protrusion (e.g., one of the protrusions 501 and 502 of FIG. 5). The protrusion may protrude from a partition wall 521 that separates the slits 321 into each of the slits 321 and contact the protruding portions 311.

In order to maintain a gap g between the protruding portions and the partition wall 521, the protrusion 501 or 502 may separate a protruding portion accommodated in a slit in which the protrusion 501 or 502 is disposed from the partition wall 521, and limit a movement of the protruding portion in a direction perpendicular to a longitudinal direction of the slit.

According to the above-described embodiment of the disclosure, the air vent assembly 140 may constantly maintain a width of the gap g through the protrusions 501 and 502. Gas released from a molding material R and air in a cavity (e.g., the cavity 104 of FIG. 2) may be discharged to an outside through the gap g maintained at the constant width.

According to an embodiment of the disclosure, the first part 310 may include a set 411 of first bridges connecting an end of the plurality of protruding portions 311 and a set 412 of second bridges spaced apart from the set 411 of first bridges and connecting another end of the plurality of protruding portions 311. According to an embodiment of the disclosure, a space between the set 411 of the first bridges and the set 412 of the second bridges may be continuous(or connected) with the gap g.

According to an embodiment of the disclosure, each of bridges of the set 411 of first bridges and the set 412 of second bridges may include a groove dug along an edge contacting the plurality of protruding portions 311.

The groove may be continuous with the space.

Each of bridges of the set 411 of first bridges and the set 412 of second bridges may support the partition wall 521.

The first part 310 may further include a concave portion (e.g., the concave portion 403 of FIG. 4A). The concave portion 403 may be dug from a side surface of a base 401 inserted into the receiving groove 550.

The concave portion 403 and the gap g may be connected so that gas in the gap g moves between the concave portion 403 and the receiving groove 550.

Each edge of the base 401 may be chamfered.

The second part 320 may further include a side wall 511, 512, 513, or 514 forming a side surface of the second part 320.

The second part 320 may further include a fastening groove 581, 582, 583, or 584 formed in a corner of the side wall 511, 512, 513, or 514 to be coupled to an external structure.

According to an embodiment of the disclosure, the first part 310 may include a hole.

According to an embodiment of the disclosure, the hole may be configured to separate the first part 310 from the second part 320 according to a pressure of the second part 320 by an external object inserted into the hole.

According to an embodiment of the disclosure, the protrusion 501 or 502 may be protruded from the partition wall 521 by 0.005 mm to 0.015 mm.

According to an embodiment of the disclosure, another protrusion 501 or 502 disposed in the slit where the protrusion 501 or 502 is disposed may be spaced apart from the protrusion 501 or 502 by a first distance.

According to an embodiment of the disclosure, the first distance may be 2 mm to 4 mm.

According to an embodiment of the disclosure, a distance between a protruding portion disposed within a slit of the plurality of slits 321 and the partition wall 521 forming the slit may be 0.05 mm to 0.015 mm.

The second part 320 may be formed of one material.

The second part 320 may include a first side wall 511, 512, 513, or 514 and a second side wall 511, 512, 513, or 514 extending in a first direction perpendicular to the first side wall 511, 512, 513, or 514 and longer than the first side wall 511, 512, 513, or 514.

The plurality of slits 321 may be parallel to the first side wall 511, 512, 513, or 514 and spaced apart from each other in the first direction.

Gas located at a front portion of the second part 320 may move to a rear portion of the first part 310 through the gap g.

According to an embodiment of the disclosure, an injection molding device (e.g., the injection molding device 100 of FIG. 1) may comprise a first mold (e.g., the first mold 101 of FIG. 1) and a second mold (e.g., the second mold 102 of FIG. 2). The first mold 101 may include a cavity 104 configured to accommodate a resin R. The second mold 102 may include a core 120 configured to press the resin R accommodated in the cavity 104, and may be configured to be movable relative to the first mold 101. The injection molding device 100 may further include an air vent assembly (e.g., the air vent assembly 140 of FIG. 1).

The air vent assembly (e.g., the air vent assembly 140 of FIG. 1) may comprise a first part (e.g., the first part 310 of FIG. 3) and a second part (e.g., the second part 320 of FIG. 3). The first part 310 may include a plurality of protruding portions 311 protruding toward the second part. The second part 320 may include a plurality of slits (e.g., the plurality of slits 321 of FIG. 3) and a receiving groove (e.g., the receiving groove 550 of FIG. 5). The plurality of slits 321 may accommodate each of the plurality of protruding portions 311. The receiving groove 550 may provide a space in which the first part 310 is disposed. The first part 310 and the second part 320 may be integrally formed and may be formed of a metal material.

According to the above-described embodiment of the disclosure, an air vent assembly 140 may provide an air vent assembly formed of a single material, thereby shortening a vent portion and enabling stable discharge of gas. By shortening a height of the air vent assembly 140, it may be disposed on a mold and stably fixed.

Each of the slits 321 may include a protrusion (e.g., one of the protrusions 501 and 502 of FIG. 5). The protrusion may protrude from a partition wall 521 that separates the slits 321 into each of the slits 321 and contact the protruding portions 311.

In order to maintain a gap g between the protruding portions and the partition wall 521, the protrusion 501 or 502 may separate a protruding portion accommodated in a slit in which the protrusion 501 or 502 is disposed from the partition wall 521, and limit a movement of the protruding portion in a direction perpendicular to a longitudinal direction of the slit.

According to the above-described embodiment of the disclosure, the injection molding device 100 may remove gas generated from a resin injected into the mold by including the air vent assembly 140. By removing gas or air in the mold through the air vent assembly 140, a quality of a molded product may be improved, and corrosion or contamination of the mold may be reduced.

According to an embodiment of the disclosure, the first part 410 may include a set 411 of first bridges connecting an end of the plurality of protruding portions 311 and a set 412 of second bridges spaced apart from the set 411 of first bridges and connecting another end of the plurality of protruding portions 311. According to an embodiment of the disclosure, a space between the set 411 of the first bridges and the set 412 of the second bridges may be continuous with the gap g.

According to an embodiment of the disclosure, each of bridges of the set 411 of first bridges and the set 412 of second bridges may include a groove dug along an edge contacting the plurality of protruding portions 311.

The groove may be continuous with the space.

The bridges of the set 411 of first bridges and the set 412 of second bridges may support the partition wall 521.

The first part 310 may further include a base 401 inserted into the receiving groove 550 and a concave portion 403 dug from a side surface of the base 401.

The gap g may be configured to move gas in the gap to an interval between the recess and the receiving groove.

The effects that can be obtained from the disclosure are not limited to those described above, and any other effects not mentioned herein will be clearly understood by those having ordinary knowledge in the art to which the disclosure belongs, from the following description.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for“ or ”means.”

What is claimed is:

1. An air vent assembly comprising:
a first part including a plurality of protruding portions; and
a second part formed as a single unit and configured with a metal material, the second part including:
a plurality of slits into which each of the plurality of protruding portions of the first part is inserted, and
a receiving groove in which the first part is accommodated,
wherein each of the plurality of slits includes a protrusion protruding from a partition wall that separates the plurality of slits into each of the plurality of slits, the protrusion contacting the plurality of protruding portions, and
wherein the protrusion maintains a gap between the plurality of protruding portions and the partition wall, by separating a protruding portion accommodated in a slit from the partition wall and limiting a movement of the protruding portion in a direction perpendicular to a longitudinal direction of the slit.

2. The air vent assembly of claim 1,
wherein the first part includes:
a set of first bridges connecting an end of the plurality of protruding portions, and
a set of second bridges spaced apart from the set of first bridges and connecting another end of the plurality of protruding portions, and
wherein a space between the set of first bridges and the set of second bridges is connected with the gap.

3. The air vent assembly of claim 2,
wherein each of bridges of the set of first bridges and the set of second bridges includes a groove dug along an edge contacting the plurality of protruding portions, and
wherein the groove is connected with the space.

4. The air vent assembly of claim 2, wherein each of bridges of the set of first bridges and the set of second bridges supports the partition wall.

5. The air vent assembly of claim 4,
wherein the first part further includes
a base inserted into the receiving groove, and
a concave portion dug from a side surface of the base, and
wherein the concave portion is connected to the gap.

6. The air vent assembly of claim 5, wherein each corner of the base is chamfered.

7. The air vent assembly of claim 1, wherein the second part further includes
a side wall forming a side surface of the second part, and
a fastening groove formed in a corner region defined by the side wall to be coupled to an external structure.

8. The air vent assembly of claim 1,
wherein the first part defines a hole, and
wherein the hole is configured to separate the first part from the second part according to a pressure of the second part by an external object inserted into the hole.

9. The air vent assembly of claim 1, wherein the protrusion is protruded from the partition wall by 0.005 mm to 0.015 mm.

10. The air vent assembly of claim 1, wherein the protrusion is spaced apart from another protrusion disposed in the slit where the protrusion is disposed by a first distance.

11. The air vent assembly of claim 10, wherein the first distance is 2 mm to 4 mm.

12. The air vent assembly of claim 11, wherein a distance between a protruding portion disposed within a slit of the plurality of slits and the partition wall forming the slit is 0.05 mm to 0.015 mm.

13. The air vent assembly of claim 12, wherein the second part is formed of one material.

14. The air vent assembly of claim 1,
wherein the second part includes a first side wall and a second side wall extending in a first direction perpendicular to the first side wall and longer than the first side wall, and
wherein the plurality of slits are parallel to the first side wall and spaced apart from each other in the first direction.

15. The air vent assembly of claim 1, wherein the gap is configured to move gas located at a front portion of the air vent assembly to a rear portion of the air vent assembly.

16. An injection molding device comprising:
a first mold including a cavity configured to accommodate a resin;
a second mold including a core configured to press the resin injected in the cavity and configured to be movable with respect to the first mold; and
an air vent assembly configured to transfer gas discharged from the resin to an outside of the second mold according to a pressure of the resin and coupled to a seating portion formed on the core,
wherein the air vent assembly comprise:
a first part including a plurality of protruding portions, and
a second part formed as a single unit and configured with a metal material, the second part including:
a plurality of slits into which each of the plurality of protruding portions is inserted, and
a receiving groove in which the first part is accommodated,
wherein each of the slits includes a protrusion protruding from a partition wall that separates the slits into each of the slits, the protrusion contacting the protruding portions, and
wherein the protrusion separates a protruding portion accommodated in a slit where the protrusion is disposed from the partition wall and limit a movement of the protruding portion in a direction perpendicular to a longitudinal direction of the slit while the resin is injected into the cavity.

17. The injection molding device of claim 16,
wherein the first part includes a set of first bridges connecting an end of the plurality of protruding portions and a set of second bridges spaced apart from the set of first bridges and connecting another end of the plurality of protruding portions, and
wherein a space between the set of first bridges and the set of second bridges is connected with a gap.

18. The injection molding device of claim 17,
wherein each of bridges of the set of first bridges and the set of second bridges includes a groove dug along an edge contacting the plurality of protruding portions, and
wherein the groove is connected with the space.

19. The injection molding device of claim 17, wherein the bridges of the set of first bridges and the set of second bridges supports the partition wall.

20. The injection molding device of claim 19,
wherein the first part further includes a base inserted into the receiving groove and a concave portion dug from a side surface of the base, and
wherein the gap is configured to move gas in the gap to an interval between a recess and the receiving groove.
